(19) United States
(12) Patent Application Publication
(10) Pub. No.: US 2004/0181404 A1
(43) Pub. Date: Sep. 16, 2004

(54) Weather radio with speech to text recognition of audio forecast and display summary of weather

(76) Inventor: Jonathan Elias Shedd, St. Louis, MO (US)

Correspondence Address: JONATHAN ELIAS SHEDD, 501 BORTHERTON LANE, ST. LOUIS, MO, 63135-3110, US

(21) Appl. No.: 10/708,413

(22) Filed: Mar. 1, 2004

(30) Foreign Application Priority Data
Mar. 1, 2003 (GB) 0304728.9

(51) Int. Cl. G10L 15/26; H04N 7/173; G10L 15/00

(52) U.S. Cl. 704/235

(57) ABSTRACT

This device uses a communication link to obtain audio weather information then uses a voice recognition means to convert the audio weather information into text, then converts this text information into display information. This device uses a means selecting means to evaluate the text and determine what text is to be displayed. This device uses a display to display weather information. This device displays weather information and, can play aloud the transmitted broadcast.

### BACKGROUND OF INVENTION

This invention relates to weather warning and weather indicating systems and, more particularly, to a weather indicating apparatus and method for providing notification of weather-related events by displaying weather information on a display.

Interest in weather-related events has increased during recent years. Hikers, bicyclists, campers, building contractors, and others are dependent on accurate weather forecasting and real-time weather information in planning and changing their outdoor activities. Currently, weather information are continuously broadcasted through a special weather radio signal on the VHF band, ranging between 162.400 and 162.550 MHz, which is outside the AM and FM broadcast bands. This special radio signal is provided by the National Oceanic and Atmospheric Administration (NOAA). Special weather radios must be used in order to receive these types of weather broadcasts. Weather messages are repeated every 4 to 6 minutes and are routinely updated. The weather broadcasts may also include severe weather warnings that pose a threat to life and safety.

Retrieving weather forecast information is a slow and awkward process. There currently exists many means of conveying the forecast, however no single means is quick, easy to understand, accurate and continuously available.

Public access Television forecasts are only sporadically available.

Television, cable and satellite weather channels provide so much weather information that the user must often wait to find a forecast that applies to them. A forecast that is relevant to the user is not continuously available.

The internet is to burdensome due to the typical time it takes to log on, start up your computer, navigate to the proper website etc.

Public access radio often plays weather forecasts but at infrequent intervals. The user must wait until the forecast is broadcast. Then they must wait through the forecast until the needed information is given.

Barometric weather trend indicators indicate a general summary of the weather forecast. These indicators generate such a prediction by measuring barometric pressure. This method of weather forecasting creates a short term forecast that is less detailed and less accurate than weather forecasts generated by trained meteorologists using all the modern meteorological tools.

A NOAA weather radio, which provides a continuous audio weather forecast, takes several minutes to cycle through all the weather information. Unnecessary and unwanted information must often be heard before desired information.

In light of the aforementioned devices, it can be appreciated that an object of this invention is to continuously display accurate weather forecast information.

It is an object of this invention to provide a device, which displays the weather forecast. The display of the forecast allows the user to have instant access to the weather forecast by reading the display.

It can be appreciated that a visual display can relay a summary of the weather forecast much more quickly than an audible means. Visual displays, display several pieces of information at once and allow the user to read what information that is important to them.

It is the principal object of this invention to provide a means of continuous and accurate weather display. It is another object of this invention to use a voice recognition means to convert audio weather information (speech) into text. It is another object of this invention to organize and summarize information onto a display.

It is yet another object of this invention to continuously or at least periodically monitor the weather information. This device provides the most current weather information when continuously monitoring but also uses the most energy. It may be practical, particularly in battery operated models, to interrupt monitoring for predetermined periods of time.

### SUMMARY OF INVENTION

This present invention combines a weather information retrieving device with a display and voice recognition means. From this new combination a user can view weather information generated by a trained meteorologist using all the modern meteorological tools. This device uses a communication links 240 and 241 to transfer audio weather information from data source 280. This device uses a voice recognition means to translate the received audio weather information into text. The text information is then sorted and displayed on a display. The display is used to display relevant weather conditions and forecasts such as high and low temperatures, cloud cover, precipitation and wind speed. The user can also use this device to listen to audible weather information, as one would with a weather radio.

This device receives the transmitted audio signal by communication link (240). The signal is sent to a processor (210) that uses a voice recognition means stored in memory (250), to translate the received audio weather information into text. Once the audio weather information is translated to text, the text is evaluated by the selecting means.

The purpose of the selecting means is to retrieve desired information out of the of the body of text that is created by the voice recognition means. This desired information is then arranged for display on the display. The means for selecting evaluates the text and controls what information the display displays. The means for selecting essentially comprehends the words that are translated to text by the voice recognition means and arranges them for display. Selecting what information to display such as temperatures, cloud cover, precipitation etc. can be preprogrammed into the device 100 or can be determined by the user via user input 220. The means for selecting converts the text into data by recognizing what information is being relayed in the text and the value of that information. In this case of weather information, the information is typically temperatures level of cloud cover, chance of precipitation etc.

The NOAA uses an automated voice to read aloud or recite the audio weather information. The format used to relay the weather information by the NOAA is similar all over the US.

Logic combines the calendar which is stored in the memory, with the days of the week. For example, this enables the device to translate “for tomorrow” to “Wednesday” and vise versa. The voice uses the same or nearly the same text time after time. For example, when the words “For today” are read the information immediately following, pertains to the current days weather information. This logical system of determining what information is being relayed is used to determine the information that will be displayed.

In the second preferred embodiment display 230 includes a scrolling text. This information is translated from speech to text but can be scrolled through by the user using user input 220.

In areas where weather conditions change suddenly over short distances the NOAA will specifically refer to and give forecasts for more than one distinct areas on a single transmitter. This typically happens in areas where the terrain changes rapidly. For the correct forecast to be displayed the device 100 must distinguish between the forecasts. The user may indicate with user input 220 which areas forecast is to be displayed. The device 100 determines which area is being addressed by language used. Providing the device with the relevant vocabulary enables it to distinguish between the two sets of weather information.

Satellite radios (radios broadcast from satellites instead of ground based transmitters) are becoming increasingly popular. One embodiment of this device receives satellite transmissions of audio weather information. This embodiment has a larger geographical vocabulary than other embodiments. This larger vocabulary enables this device to distinguish smaller regions from larger ones. Presumably weather transmissions from satellite would be for a much greater area than ground based weather transmissions. This larger area would require the broadcaster to refer to different areas and give the weather forecast for these different areas.

### BRIEF DESCRIPTION OF DRAWINGS

The preferred embodiments of the present invention will hereinafter be described in conjunction with the appended drawings, where like designations denote like elements, and:

FIG. 1 is a view of the preferred embodiment of the weather indicating device;

FIG. 2 is a block diagram schematic representation of the preferred embodiment;

FIG. 3 is a flow diagram of a method for displaying weather data.

### DETAILED DESCRIPTION

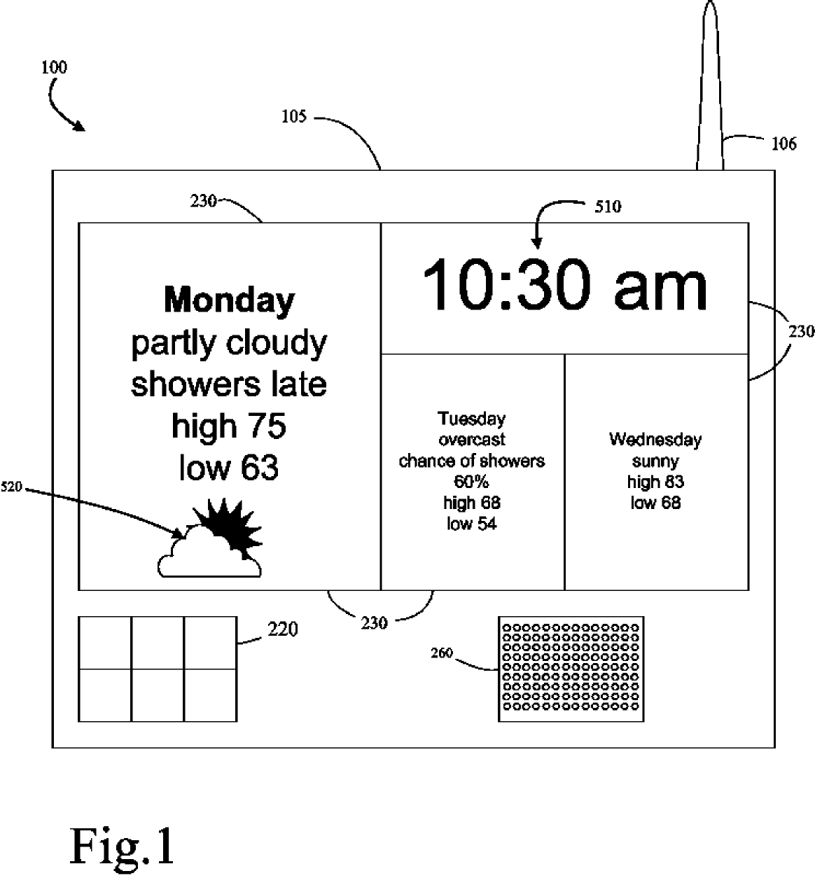

Referring now to the drawings, and to FIG. 1 in particular. The weather forecasting device 100 includes housing 105 that accommodates display 230, speaker 260 and antennae 106. Device 100 also includes user input 220 and a power source (not shown). The display 230, and user input 220 is preferably located on the front of housing 105. The weather indicating device 100 is preferably connected to a household power source (not shown) or may include a power source, and/or backup power source, such as a battery, solar cell, or the like, for providing electrical power to the electronic components in apparatus 100.

Device 100 may also be combined with a receiver capable of receiving and displaying time on display 230, transmitted from atomic clocks that broadcast the time such as the signal broadcast by NIST in Boulder, Colo.

Device 100 also includes a preferred embodiment which shows housing 105, display 230, atomic time and date 510 and user input 220. Also included on display 230 are summaries of weather forecasts for each day shown. Shown in display 230 is a forecast of the present day in combination with a two day outlook. However, any number of variations to this display 230 are possible while not departing from the scope of this invention including but not limited to, long range forecasting, showing any of a range of possible number of days forecasts and any combination of graphics used.

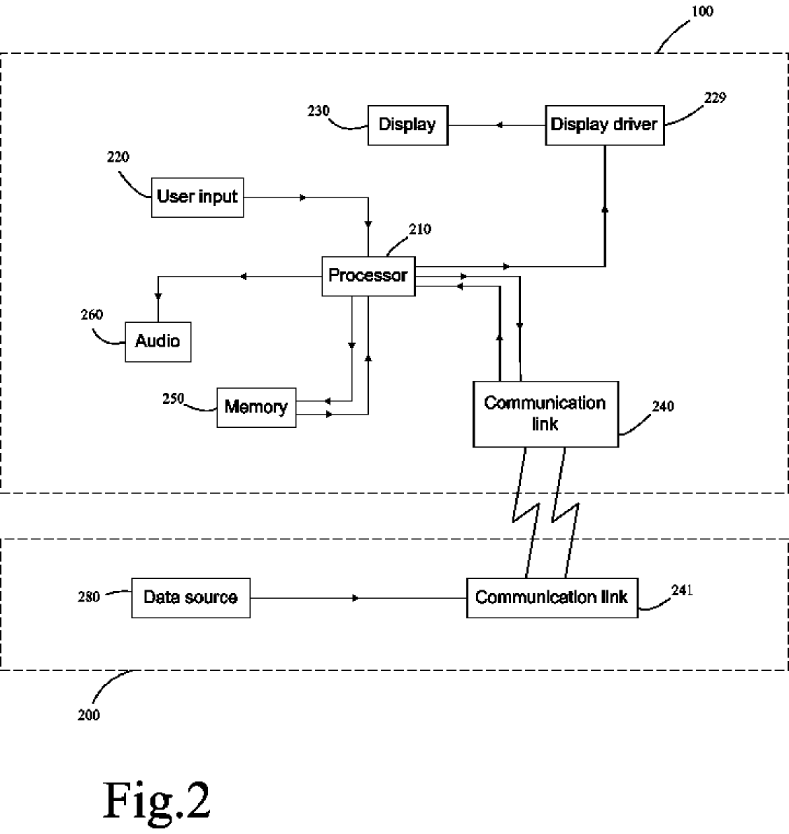

Referring now to FIG. 2, a block diagram schematic representation of device 100 and remote source 200. Device 100, includes a processor 210, user input 220, display driver 229, display 230, communication link 240, memory 250, and audio 260, which is coupled via communication link 240 and communication link 241 to remote source 200. Remote source 200 includes data source 280 and communication link 241.

While the processor 210 is preferably a single-chip processor, processor 210 also encompasses any number of integrated circuits and circuit boards working in cooperation to perform the functions of a processor.

User input 220 represents any suitable means for a user to input information to apparatus 100. Of course, many other types of user input means fall within the scope of the present invention, including without limitation keypads, voice recognition, etc. Any means for a user to provide input to device 100 is within the scope of the present invention, whether the means exists today or are developed in the future.

Communication links 240 and 241 comprise any suitable means for transferring information between remote source 200 and device 100. Communication links 240 and 241 preferably includes a radio frequency tuner (receiver), and may include one or more antennae or other mechanical or electrical apparatus for communicating between transmitter and device 100. Alternatively, communication links 240 and 241 may include a means for transmitting and receiving a non-radio frequency in the electromagnetic spectrum for communicating between remote source 200 and device 100.

Remote source 200 comprises communication link 241, for communicating with device 100, and data source 280 for providing data to communication link 241.

Data transfer between the communication links 240 and 241 is preferably accomplished in the VHF band, in the frequency range from 162.400 to 162.550 MHz. However, any means for transferring data between the remote source 200 and device 100 in the electromagnetic spectrum can be used within the scope of the present invention, including without limitation frequency modulation, amplitude modulation, modem, microwave circuitry, or other means for transmitting information from one location to another.

The NWS provides the NOAA with weather information. The NOAA sends weather related transmissions from transmitters all across the country. These transmitters serve as remote transmitters for all the weather receivers across the country. The NWS serves as the data source 280 for supplying weather related information to the transmitters for transmitting.

This device is equipped to receive weather information from the NOAA and other weather data providers that provide weather information such as temperature, humidity, chance of precipitation, type of precipitation, tornado and severe weather warnings, watches and statements, high wind watches and warnings, dense fog advisories, winter storm watches and warnings, freezing precipitation advisories, avalanche bulletins, hurricane warnings, watches and statements, blizzard warnings, flood warnings watches and statements, or any other weather-related data. In addition, non-weather-related alerts, such as nuclear attack warnings and civil emergencies, can also be provided by remote source 200 to device 100.

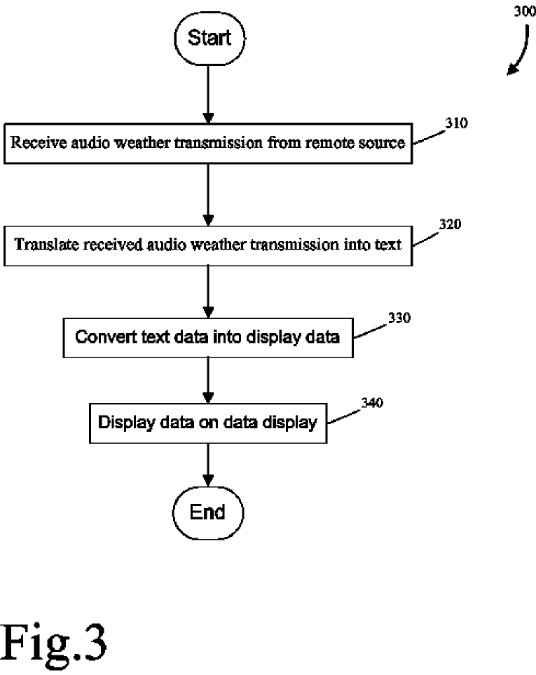

Referring now to FIG. 3, a method 300 for receiving and displaying weather data on a weather indicating device 100 according to the first embodiment of the invention is illustrated. First the weather indicating device 100 receives audio weather data from a remote source (step 310). In the preferred embodiment this step is accomplished by receiving signal through communication link 240. Next the audio data is converted into text data (step 320) using the voice recognition means. This text data is then converted into display data (step 330). Then display data is displayed on data display (step 340).

The text data is converted into display data (step 330) by but not limited to the following means. Searching through the translated text for words and phrases. When a particular word or phrase is found, they are displayed on display 230. The display 230 is often simply displaying the word or phrase found in the text. However, a word or phrase can also be translated to a graphical image 520. For example, if the phrase “sunny this afternoon” is found the display 230 can show the words “sunny this afternoon” as well as displaying a graphic meaning the same.

One method of converting text data into display data (step 330) includes identifying the date, which piece of information is being referred to and the value of that information. It must be understood if the text relays high temperature, low temperature, cloud cover, precipitation etc. The device must also determine the value of what is being related. For example, this enables the device to display “Wednesday low temperature 35°”, “Tomorrow cloud cover mostly cloudy”, “Friday 60 percent chance of rain” etc.

One embodiment of step 330 includes a method that determines when the text says a particular event is going to happen. This method searches for word and phrases, that are known to be used to describe weather conditions, that refer to a date or time. For example the phrase “rain on Wednesday” indicates that rain is in the forecast for Wednesday. All known word and phrases that are known to be used to indicate weather conditions are preprogrammed into the device. Each word or phrase has a predetermined output command. For example the phrase “rain on Wednesday” is accompanied by the command to place rain in the portion of the display 230 designated for Wednesday.

This method includes all the wordings that can refer to a particular date including those that do not use the name of that day. For example, if today were Monday and forecast provider gave the statement “rain the day after tomorrow” in place of the statement “rain on Wednesday” the device would still be able to place rain in the appropriate portion of the display. The device is equipped with a calendar and knows the current day and deduces that the day after tomorrow is Wednesday.

Device 100 has a vocabulary that is sufficient to provide a display output that accurately represents the translated text. In this manner device 100 is capable of accurately handling a diverse language.

One method of improving the recognition of weather information is to train the voice recognition means to recognize the voice of a specific person or persons that is known to relay weather forecasts. This device can also be trained to recognize a voice or voices that are generated by computer, or otherwise synthetically generated.

Another method of improving the voice recognition means is to include in the voice recognition means all the vocabulary known to be used by the remote source 200. All words and phrases used in the broadcasts are included in the vocabulary of this device 100.

Referring to step 330. One method of translating text into display information takes advantage of the predictable and repetitive phrasings used by the transmitted audio text. In this method all vocabulary are collected and stored. The programmer manually identifies the vocabulary and tells the translating means how to respond to the vocabulary. This response is stored and enacted during translation. During translation a word or phrase used is matched with the stored word or phrase. The command associated with those word or phrase is executed. In this manner the device can select specific information, label this information, give a value to the information and then display the information on display 230.

Referring to step 330. The device must be able to understand which weather category is being addressed even when a variety of synonymous words are used to describe the weather. In NOAA forecasts, for example, temperature is often given with several wordings including, “lows forty-five to fifty-five degrees”, “lows mid forties to mid fifties”, “lows around fifty, lows near fifty”. The device is programmed to recognize all of the possible wordings and associate each wording with one of the three categories, date (what day is being referred to), parameter (what kind of information) and value (how much). In the preferred embodiment all temperatures are converted into numbers. For example, “Lows near fifty” would be converted to “50” and placed in the low temperature box.

Depending on the type of display used, a suitable display driver 229 may be needed between the processor 210 and the display 230 for receiving display information from the processor 210 and driving display 230.

There are, of course, additional features of the invention. Those skilled in the art will appreciate that the preferred embodiments may readily be used as a basis for designing other structures, methods and systems for carrying out purposes of the present invention. It is important, therefore, that the claims be regarded as including such equivalent constructions since they do not depart from the spirit and scope of the present invention. The foregoing and other features and advantages of the invention are apparent from the description of preferred embodiments of the invention, as illustrated in the accompanying drawings.

I claim

1. A weather indicating device comprising;
a)a communication link for receiving audio weather information, and
b)a voice recognition means for translating the received audio weather information into text, and
c)a selecting means for selecting and arranging predetermined information found in the text into a format useful for displaying, and
d)a display means.

2. The communication link of claim 1 wherein the communication link comprises;
a)a weather data source, and
b)a remote transmitter linked to the weather data source, for transmitting the audio weather information, and
c)a receiver, for receiving remote transmissions from the remote transmitter.

3. The receiver of claim 2 wherein;
the receiver receives NOAA transmissions.

4. The receiver of claim 3 wherein;
the receiver receives public service band between 162.400 and 162.550 megahertz (MHz).

5. The communication link of claim 1 wherein;
the communication link receives satellite transmissions.

6. The voice recognition means of claim 1 wherein;
the voice recognition means has been trained to recognize voices used to relay audio weather information.

7. The voices of claim 6 wherein;
the voices that relay weather forecast information are synthetically generated.

8. The voice recognition means of claim 1 wherein;
the voice recognition means has a vocabulary comprising the words used by the broadcaster.

9. The selecting means of claim 1 wherein;
the means for selecting can be modified by the user; for allowing the user to select the information displayed.

10. The display of claim 1 wherein;
the display is a liquid crystal display.

11. The display information of claim 1 wherein;
the display information includes a summary of the weather forecast.

12. The display means of claim 1 wherein the display means comprises;
a display driver and
a display.

13. A method of receiving and displaying weather information wherein the method comprises;
a)receiving an audio weather transmission from a remote source and,
b)translating the audio weather transmission into text,
c)converting the text into display data and,
d)displaying the display data on the display.

14. The remote source of claim 13 wherein the remote source comprises;
a remote transmitter for transmitting audio weather information.

15. The remote transmitter of claim 14 wherein the remote transmitter comprises;
a NOAA weather broadcast.

16. The NOAA weather broadcast of claim 15 wherein the NOAA weather broadcast comprises;
transmissions on the public service band between 162.400 and 162.550 megahertz (MHz).

17. The translating of claim 13 wherein the translating comprises;
using a voice recognition means to translate the audio weather transmission into text.

18. The converting of claim 13 wherein the step of converting includes;
selecting predetermined information found in the text and arranging the information into a format useful for displaying.
